(19) United States
(12) Patent Application Publication
(10) Pub. No.: US 2007/0081920 A1
(43) Pub. Date: Apr. 12, 2007

(54) Semi-disposable optoelectronic rapid diagnostic test system

(76) Inventors: R. Sean Murphy, Sunnyvale, CA (US); Robert H. Yi, San Jose, CA (US); Brenton A. Baugh, Palo Alto, CA (US); Robert E. Wilson, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/248,454

(22) Filed: Oct. 12, 2005

(51) Int. Cl. G01N 31/22

(52) U.S. Cl. 422/58

(57) ABSTRACT

A hand-held optoelectronic test system comprising a cartridge including at least one light source and sensors prealigned to permit acquisition of electro-optic data from a fluid sample reacted with a reagent, such as upon a test membrane in a reaction zone, and a reader which processes the acquired data to identify a physical change in the fluid sample. The cartridge and reader are operable for separate predetermined or controllable finite numbers of tests before becoming disposable.

### BACKGROUND OF THE INVENTION

This invention relates generally to in vitro diagnostic (IVD) test systems, and, more particularly, to optoelectronic test systems used in measuring biological compounds in body fluids.

IVD test systems are available for a wide variety of medical and environmental conditions. Several types of assay formats exist, all of which involve reacting a body fluid sample (such as saliva, blood, or urine) with a reagent to yield a physically detectable change. An example of such a test system is the Linear Flow Assay (LFA), which is commonly used for pregnancy tests. In this type of test system, a urine sample flows over a chemically treated material such as nitrocellulose located inside the testing device. The presence of an analyte in the urine sample generally results in a visually detectable coloring of a test strip which indicates pregnancy.

Since the intensities of the colors, labels, and markers in the various test systems can vary and can degrade rapidly after the reaction occurs, users of such tests may have difficulty in visually interpreting a test result. Therefore, several optoelectronic test systems have been developed to measure the color and/or intensity of the induced physical changes.

Three classes of optoelectronic test instruments have been developed to perform such testing. The first class includes large, highly accurate desktop units that use disposable single- or multiple-assay test substrates. A disadvantage of this class of test system is its high cost, which relegates these test systems to use in a few central laboratories, thus requiring shipment of samples which results in delays in processing and return of results. In addition, contaminants are required to be cleaned from such systems in between testing in order to prevent test corruption. Finally, the test substrate or sample container must be aligned correctly with the optical system for proper operation.

The second class of optoelectronic test systems are less expensive, hand-held, disposable units that enclose a single test substrate and are discarded after use. U.S. Pat. No. 5,837,546 to Allen, et al., discloses an example of this class of test system. The disadvantages of this class of test system include limited functionality, sensitivity, and dynamic range, and a relatively high cost on a per test basis, as the cost of the device cannot be amortized over multiple tests.

U.S. Pat. No. 5,656,503 discloses a hybrid class of optoelectrical test systems, as embodied in pregnancy test products of Unipath, LLC. Such systems are typically comprised of a disposable hand-held device containing instrumentation to illuminate and observe a fluid sample, but employ disposable test substrates. While less expensive than other test systems, this hybrid class similarly experiences the alignment and contamination problems of the desktop class.

Thus, there is a need to provide a low-cost optoelectronic test system which has a low risk of contamination in between sample tests and for which assuring the proper alignment of the illumination source and/or detection optics with the sample under test is not a necessary part of the test process.

### SUMMARY OF THE INVENTION

The needs of the invention set forth above as well as further and other needs and advantages of the present invention are achieved by the embodiments of the invention described hereinbelow.

The present invention provides a rapid diagnostic assay test device, and method of use thereof, for determining whether a fluid under test contains a certain substance by sensing an optical change in the fluid (or test substrate). A test device in accordance with the present invention comprises a semi-disposable, two-part optoelectronic system that allows wide, point of care dissemination without the high initial cost, contamination or optical alignment problems of desktop devices.

In one embodiment, the test device includes a cartridge and a reader, wherein all optoelectronic elements involved in acquiring data from the fluid sample are integrated and optically aligned within the cartridge and only data is transferred between the cartridge and reader. The cartridge includes a reaction zone containing an analyte capture reagent that, when reacted with the fluid sample, induces an optical change in the sample, and at least one light source within the cartridge for emitting light incident upon the reaction zone. One or more optoelectronic sensors are positioned within the cartridge so as to detect light emanating from the reaction zone. The sensor(s) output data to the reader through a mateable interface. This interface also transfers power from the reader to the optoelectronic elements in the test cartridge. The reader includes a microprocessor that interprets the sensor data to generate test results.

The microprocessor may determine a time interval over which valid sensor data may be acquired from the cartridge, and may convey the test results to one or more external displays and/or databases through another interface such as, for example, a USB port or other serial connection. The microprocessor may also store the test results in non-volatile memory within the reader, and/or provide an indication, such as through one or more light emitting diodes or a liquid crystal display, of the test results. The microprocessor may also indicate the operational status of the reader through such means.

The present invention may be adapted to a variety of assay formats including, but not limited to, linear flow assays, optical immunoassays, micro-fluidic assays, and fluorescent label molecule assays. Certain of these assays operate by transporting the fluid sample to the reaction zone for reaction with the analyte capture reagent, whereas others involve directly dispensing the fluid sample into the reaction zone.

As will be described below, the test device is semi-disposable, in that the cartridge is intended to be single-use, whereas the reader is intended to be used multi-use. The test device optionally includes means for limiting the number of tests in which the reader may be utilized.

For a better understanding of the present invention, together with other and further objects thereof, reference is made to the accompanying drawings and detailed description and its scope will be pointed out in the appended claims.

### BRIEF DESCRIPTION OF THE FIGURES

FIGS. 1A-1C are illustrations, including an exploded view, of an embodiment of a rapid diagnostic assay test device in accordance with the present invention;

FIGS. 2A-2D are partial views of an embodiment of a rapid diagnostic assay test device in accordance with the present invention illustrating a configuration of electro-optical elements for detecting a change in light emanating from a reaction zone within a cartridge; and

FIG. 3 is a block diagram of functional components of a cartridge and reader in accordance with an embodiment of the present invention.

### DETAILED DESCRIPTION OF EMBODIMENTS OF THE INVENTION

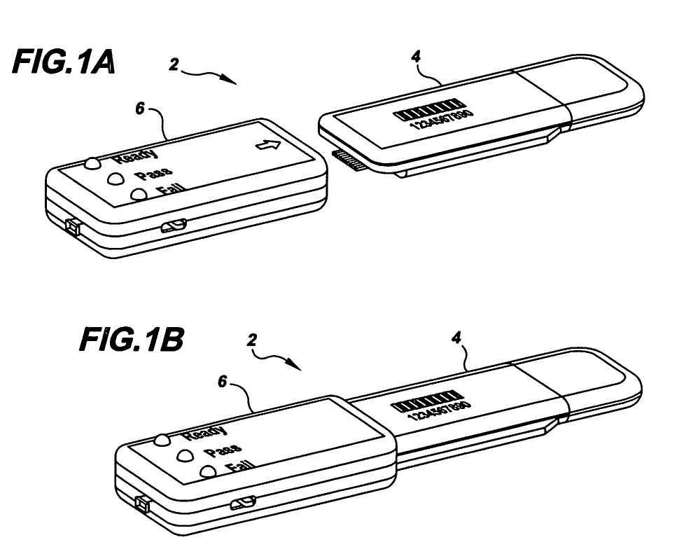

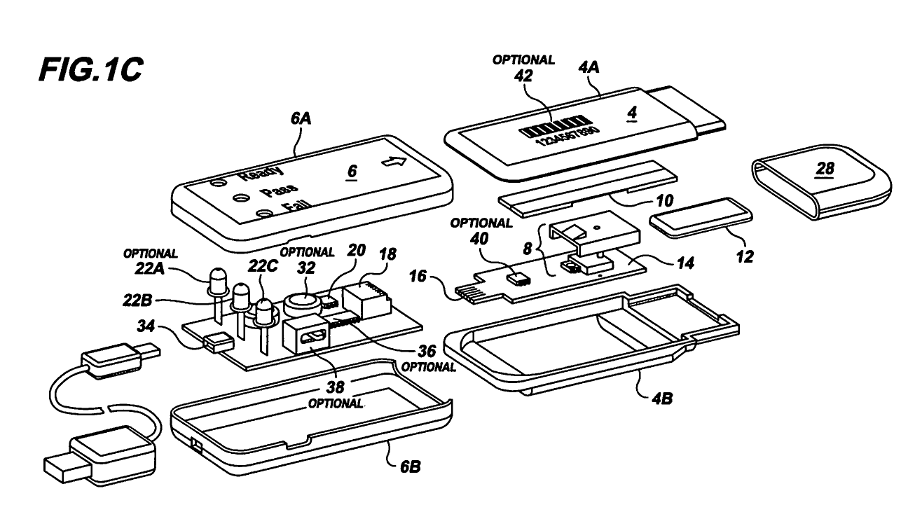

The present invention provides a semi-disposable, rapid-diagnostic test device that allows wide, point-of-care dissemination without the high initial cost and contamination risks of desktop systems, or the optical alignment problems of low-cost, handheld assay systems, wherein any misalignment of a sample and a reader may result in greater errors than are acceptable. A hand-held test device 2 in accordance with the present invention is illustrated in FIGS. 1A-1C. Test device 2 is comprised of two major components, a sample cartridge 4 and a reader 6.

FIG. 1C presents an exploded view of top 4A and bottom 4B parts of cartridge 4, and top 6A and bottom 6B parts of reader 6, each of which can be molded from low cost plastic. A fluid sample to be analyzed is deposited upon a sample receptor 12 (e.g., collection pad) prior to analysis, and the receptor 12 may then be covered by a plastic “yuck” cap 28 in order to prevent contamination of the fluid sample during further handling. Cartridge 4 and reader 6 are mateable such that an electrical connection is formed between circuitry present in each component. Sample cartridge 4 also contains electro-optics 8 for illuminating and detecting light emanating from a reaction zone 10, and circuitry 14 including transmission lines in a printed circuit board for transferring sensor output data from the illumination/detection electro-optics 8 to an interface 16. Interface 16 forms an electrical connection with a corresponding interface 18 in reader 6 through which sensor output data from the illumination/detection optics 8, and optionally cartridge identification information from an EEPROM 40, is communicated to a microprocessor 20 in the reader to process, interpret, and store (in optional non-volatile memory) the electrical information (e.g., sensor output and cartridge identification data) from the sample cartridge, and optionally one or more external indicators 22A-22C such as, for example, LED lighting or liquid crystal display) to acknowledge operation of the system and present the results of the test. Thus, only the electrical mating between the test cartridge and reader is essential, as proper alignment between the optics and the reaction zone (e.g., including an LFA test substrate) is inherent in the cartridge design. In addition, the potential for sample contamination of the reader 6 is negated, as the fluid sample is confined to the test cartridge, with only data and power being transferred between the cartridge and reader, and since the test cartridge 4 (and embedded electro-optic sensor) is discarded after a single use.

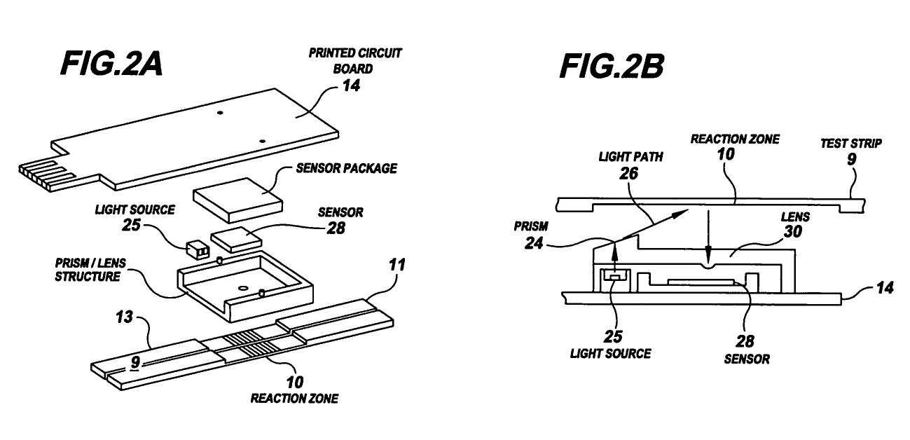

In the linear flow assay (LFA) embodiment of the invention illustrated in FIGS. 2A-2B, at least one light source 25 emits radiation that follows a light path 26 that is incident upon the reaction zone 10 after deflection through a lens or prism 24. Reaction zone 10 comprises a section of test strip 9 where the fluid sample has been reacted with at least one capture reagent immobilized on a stripe to induce a detectable physical change in the fluid sample indicative of the presence or absence, as appropriate, of one or more desired analyte(s.) When multiple capture reagents are immobilized in distinct stripes, visibly distinctive lines may appear on the test strip. The presence of the analyte(s) in the sample results in a visually detectable coloring of the stripe(s) in the reaction zone. In such embodiments, a corresponding number of light sources each illuminating the different zones of the test strip, and/or multiple sensors for detecting light emanating from the distinct zones may be utilized. It is preferred that, where an assay result reading device includes a plurality of light sources, these are advantageously arranged such that a particular zone is illuminated only by a single one of the plurality of light sources. For example, optical baffles may be provided between or around the light sources so as to limit the portion of the test strip illuminated by each light source.

A control line may also be embedded in the test strip. The control zone is a zone of the test strip in which an optical signal is formed irrespective of the presence or absence of the analyte of interest to show that the test has been correctly performed and/or that the binding reagents are functional. A reference zone may also be utilized, wherein only “background” signal is formed which can be used, for example, to calibrate the assay result reading device and/or to provide a background signal against which the test signal may be referenced. In such instances, a comparison is made between the intensity levels of the calibration or control lines (or zone), or some other reference standard, and the detection stripe(s) of the test strip, to calculate the amount of analyte present in a fluid sample.

At least one electro-optic sensor 28 is in fixed alignment with the reaction zone 10, optionally via a prism, lens 30 or other optical feature, in order to detect the presence and intensity of any change in radiation emanating from the reaction zone. As shown, the light emanating from the zone (or from multiple zones in certain embodiments) may be light which is reflected from the test strip 9 or, in the case of configurations utilizing test strips which are transparent or translucent, light which is transmitted through the test strip. In principle, an assay result reading device 2 in accordance with the present disclosure may comprise any number of light sources 25 and any number of photodetectors (sensors) 28. There may also be more than one reaction zone in the cartridge, reading multiple assay results. For the purposes of the present specification, light incident upon a particular zone of a test strip from a light source, and reflected by the strip or transmitted therethrough, may be regarded as “emanating” from the strip, although of course the light actually originates from the light source. The one or more light source 25 illuminating the reaction zone preferably comprises one or more light emitting diodes (LED's), diode lasers or other emitters tuned to an optimum wavelength. Light emanating from the reaction zone, indicative of the physical change induced in the fluid sample, is measured by the sensor(s) 28, which preferably is a PN, PIN, or avalanche photodiode, a CMOS or CCD imaging device, or any other device capable of detecting photons and complying with the size restraints for a hand-held instrument.

In one LFA embodiment of the device 2, the fluid sample dispensed upon the collection pad (receptor 12) is transported via capillary action along test strip 9 to the reaction zone 10. The liquid sample flows from the sample receptor 12 (not shown) in contact with one padded end 11 of test strip 9 through the reaction zone 10 to a padded second end 13. In general, the fluid sample flows through this mechanism one-way along the test strip 9. The padding “pulls” the liquid containing the analyte along the membrane from one end of the membrane to another end of the membrane, through the reaction zone, where any of the analyte to be detected that is present in the fluid sample is bound to the analyte capture reagent(s) immobilized on one or more stripes. The test strip 9 may be composed of a standard cellulose ester, with nitrocellulose usually providing good results. Notably, all of the optical components required to illuminate and detect the presence and intensity of the optical change induced in the fluid sample are fixed in alignment in the disposable cartridge 4, while the electronics for processing (microprocessor 20) and storing and/or indicating the results of the test are packaged in the semi-disposable, multi-use reader 6.

It is to be understood that the invention can be configured for detecting a broad range of analytes, including therapeutic drugs, drugs of abuse, hormones, vitamins, glucose proteins (including antibodies of all classes), peptides, steroids, bacteria or bacterial infection, fungi, viruses, parasites, components or products of bacteria, allergens of all types, antigens of all types, products or components of normal or malignant cells, and the like.

The description above of an LFA embodiment of the invention is by no means intended to be limiting. Optical immuno, micro-fluidic, and fluorescent label molecule assay embodiments of the invention, for example, are considered to be within the scope of the invention. No sample receptor or fluid transport mechanisms are employed in optical immunoassay (OIA) embodiments of the present invention, wherein the fluid sample under test is directly deposited upon an optically reflective substrate (through a sample input window/port) with an analyte-binding capture reagent. In an OIA embodiment, rather than being composed of nitrocellulose material as is the test strip of the LFA embodiment, the test substrate is composed of an optically reflective surface such as, for example, silicon and the like, upon which have been formed thin molecular films of silicon or non-silicon reagents. The surface of the test substrate is optically aligned with one or more light sources and one or more photodetectors. Light emitted from the light source(s) is incident upon the substrate in the reaction zone, and the change in the reflection of light through the fluid sample and molecular thin films on the substrate is detected and one or more signals associated with the change is generated.

In micro-fluidic assay (MFA) embodiments of the invention, the reaction between the fluid sample and the analyte capture reagent is performed in a bulk fluidic state in a well or other container occupying the reaction zone, and the resulting change in light emanating from the reaction zone is similarly detected by one or more photodetectors optically aligned with the reaction zone and light source(s), all the aforementioned components being integrated within the cartridge 4. As above, the detected change in light emanating from the reaction zone results in generation of a sensor output signal (e.g., a voltage and/or current) indicative of the change, which is made available to the reader for processing into test results.

With reference again to FIG. 1C, the test device 2 preferably includes means for limiting the number of tests that the multi-use reader 6 can perform before being discarded. One approach to limiting the useful life of the reader 6 is to incorporate an energy storage unit 32 into the reader 6 that provides the power necessary to operate the reader and cartridge electronics, and design the energy storage unit 32 (e.g., one or more power cells) to become depleted of energy after a predetermined, finite number of tests are performed (plus some margin.) In an alternative embodiment, power could be provided from an external power source to the reader 6 through input/output interface 34, which may be a USB port. In such embodiments, the reader life would only be limited by wear or damage.

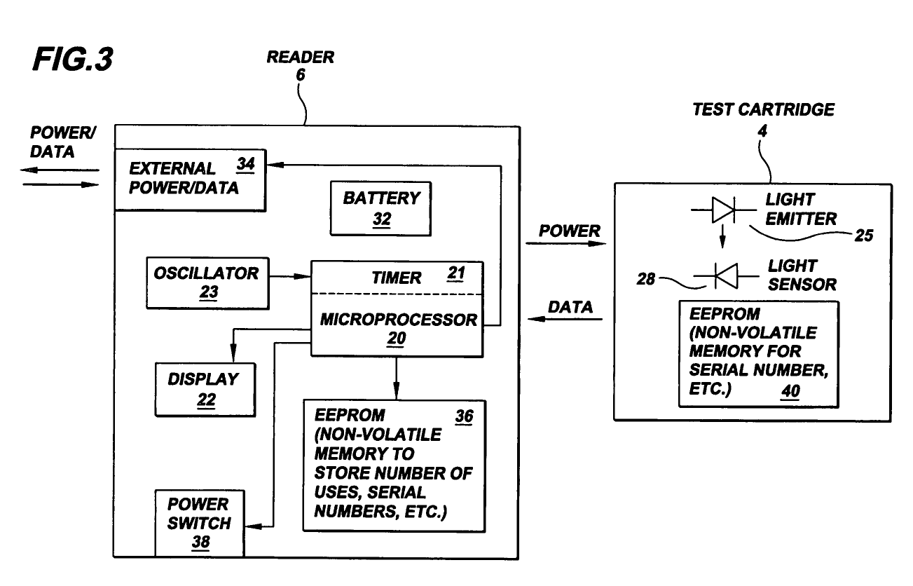

With reference to the functional diagram of FIG. 3, which illustrates that only power is transmitted from the reader 6 to the cartridge 4, and only data is transmitted from the cartridge to the reader, microprocessor 20 provides another means for limiting the operability of reader 6, and thus the entire test device 2. In a preferred embodiment, microprocessor 20 combines in a single chip the functions of program ROM memory, A/D and D/A converters, serial I/O (for printing or for external computer), internal RAM memory and a central processing unit. Its ROM is loaded with a controlling program, and the microprocessor receives indications of the coupling and decoupling of the cartridge and reader (e.g., from position detectors or monitoring circuits), test data (from the sensor(s)) and cartridge identification information (from EEPROM 40.) Microprocessor 20 directs signals to display components and the serial I/O port. A count of the number of tests that are performed by the reader 6 may be maintained in non-volatile memory 36 in communication with microprocessor 20, which monitors the test count. Upon attainment of a predetermined test count, the microprocessor 20 halts operation in any number of ways, including ceasing interpretation of sensor output data and/or outputting of test results, or by preventing power from being supplied to the illumination/detection optics 8 of the cartridge 4. Additionally, the microprocessor 20 may indicate for example, through an external indicator or data output, that the reader should be discarded. In yet other embodiments, rather than being limited by means of microprocessor monitoring of the test count, the operability of the test device may be controlled by an external control signal transmitted to the microprocessor.

With reference again to FIG. 1C, each mating of the cartridge and reader, between respective interfaces 16 and 18, results in a detectable (i.e., by completing a simple electrical circuit) electrical connection. In a preferred embodiment, the reader 6 is activated through, for example, an optional external switch 38 disposed on the reader, and the operational status of the reader is indicated (e.g., through “ready” indicator 22A.) In certain embodiments the energy storage unit 32 may alternatively be turned on or off by physically mating or decoupling the cartridge 4 and the reader 6. Upon detection of a cartridge insertion, microprocessor 20 starts an internal timer 21 (with timing signals provided by oscillator 23) in order to time an interval over which sensor output data is accepted from the cartridge (which is simultaneously and continuously detecting light emanating from the reaction zone). The fluid sample is dispensed, depending upon the particular embodiment of the invention, onto a sample receptor for fluid transport (LFA), or directly onto a reflective test substrate (OIA) or into a well (MFA) in the cartridge, for reacting with the analyte capture reagent in the reaction zone. The detected changes in light emanating from the reaction zone must be read within a specified time frame after initiating a test to produce valid results. Once the test is finished, determined either by the presence of a control strip or expiration of the timer interval, the test results are indicated (e.g., through “pass”/“fail” indicators 22B-22C) which may be followed by an automatic shut-off. The cartridge 4 can then be removed and discarded. The sensor output signals are interpreted by microprocessor 20 to determine the test results, which may be instantaneously displayed, transferred to an external display or database, and/or stored in non-volatile memory 36.

In certain embodiments, the cartridge circuitry 14 includes an electrical component (EEPROM 40) outputting a data code or serial number uniquely identifying the cartridge 4 to the microprocessor 20. Additionally, or alternatively, each cartridge 4 may have a unique identifier on an external surface of the cartridge 4 such as, for example, a label or barcode 42, which preferably matches the serial number being output by EEPROM 40. As used herein, bar code refers to a printed horizontal strip of vertical bars of varying widths, groups of which represent decimal digits or other information and are used for identification purposes. The vertical bars are also referred to herein as stripes. Bar codes are read by a bar code reader or scanner and the code interpreted either through software or a hardware decoder. The bar code may be printed in inert ink, or might be printed on a transparent overlay so as not to interfere with the test itself. Such measures are useful in maintaining confidentiality of a patient's drug and disease test results, while preserving test traceability information. The cartridge identification data may be stored in non-volatile memory 36 with the associated test results and/or transmitted from the reader to an external database or display system by USB, RS-232, wireless (WI-FI, Bluetooth, RF-ID) or other serial connection. The cartridge identification data may also include information such as the type of test, the lot number, expiration date, calibration factors, and the like.

Although the invention has been described with respect to various embodiments, it should be realized this invention is also capable of a wide variety of further and other embodiments within the spirit and scope of the appended claims.

What is claimed is:

1. An assay test device for sensing an optical change in a fluid sample, comprising:
a cartridge;
a reaction zone within the cartridge containing at least one analyte capture reagent capable of inducing an optical change in a fluid sample when reacted with the fluid sample, the reaction zone adapted to receive the fluid sample;
at least one light source within the cartridge for emitting light incident upon the reaction zone;
at least one optoelectronic sensor positioned within the cartridge so as to detect light emanating from the reaction zone and to generate associated sensor data;
an interface within the cartridge through which power is provided to the at least one light source and at least one optoelectronic sensor, and through which the sensor data is output;
a reader including an interface mateable with the cartridge interface in a data and power transferable connection, and further including a
microprocessor to generate test results by interpreting the output sensor data.

2. The assay test device of claim 1, wherein the microprocessor determines a time interval over which sensor data is acquired for interpretation from the at least one optoelectronic sensor.

3. The assay test device of claim 1, further comprising an external indicator in communication with the microprocessor for indicating data selected from the group consisting of test results and the operational status of the reader.

4. The assay test device of claim 1, wherein the at least one optoelectronic sensor is of a detector type selected from the group consisting of PN diodes, PIN diodes, avalanche photodiodes, CMOS imaging devices and CCD imaging devices.

5. The assay test device of claim 1, wherein the microprocessor monitors the number of tests performed by the reader.

6. The assay test device of claim 1, further comprising:
a sample receptor within the cartridge for receiving the fluid sample;
a test strip within the cartridge in contact with the sample receptor, the test strip including a mechanism for transporting the fluid sample from the sample receptor to the reaction zone, and a portion of which includes a stripe within the reaction zone within which the analyte capture reagent is immobilized.

7. The assay test device of claim 1, further comprising an optically reflective substrate within the cartridge, at least a portion of which is disposed in the reaction zone, said portion having immobilized thereupon the analyte capture reagent.

8. The assay test device of claim 1, wherein the sample reaction zone comprises a well for receiving the fluid sample, the well containing the analyte capture reagent in a bulk fluidic state.

9. The assay test device of claim 1, further comprising means for limiting the number of tests that may be performed by the reader.

10. The assay test device of claim 1, further comprising at least one internal energy storage unit within the reader.

11. The assay test device of claim 10, wherein the internal energy storage unit comprise one or more power cells storing enough energy to operate the reader and cartridge for a predetermined number of tests.

12. The assay test device of claim 1, further comprising an external switch for turning the reader on and off.

13. The assay test device of claim 1, further comprising circuitry within the reader for detecting mating or decoupling between the cartridge and the reader.

14. The assay test device of claim 13, wherein the detected mating initiates timing of a testing interval.

15. The assay test device of claim 1, further comprising an interface within the reader adapted to receive electrical power from an external source for operating the reader and cartridge.

16. The assay test device of claim 1, further comprising an electrical component within the cartridge for outputting a unique data code associated with the cartridge to the reader.

17. The assay test device of claim 1, further comprising an external feature on the cartridge uniquely identifying the cartridge.

18. The assay test device of claim 1, further comprising a yuck cap mateable with the sample cartridge so as to cover an opening in the cartridge through which the sample is input into the cartridge.

19. A method of sensing an optical change in a fluid sample, comprising the steps of:
providing a sample cartridge including at least one light source and at least one optoelectronic sensor aligned with a sample reaction zone;
reacting a fluid sample with a reagent in the sample reaction zone;
electrically connecting the cartridge to a reader;
outputting sensor output data from the at least one optoelectronic sensor to the reader.
